(19) United States
(12) Patent Application Publication
(10) Pub. No.: US 2006/0179967 A1
(43) Pub. Date: Aug. 17, 2006

(54) Knob for a motor vehicle control lever

(76) Inventors: Markus Egerter, Altenriet (DE); Ralf-Maria Netzker, Ludwigsburg (DE); Thomas Casper, Theley (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/537,812

(22) PCT Filed: Sep. 14, 2004
(86) PCT No.: PCT/EP04/10238

§ 371 Date: Jun. 7, 2005

(30) Foreign Application Priority Data
Oct. 27, 2003 (DE) 103 50 249.1

(51) Int. Cl. G05G 1/04

(52) U.S. Cl. 74/523

(57) ABSTRACT

A knob or grip end for a control lever of a motor vehicle includes a knob body which has a receiving device for the control lever. The receiving device has a lining made of a flexible material which is provided for fixing the knob on the control lever.

### BACKGROUND AND SUMMARY OF THE INVENTION

This invention relates to a knob for a control lever of a motor vehicle.

Control levers, such as shifting or selecting levers for motor vehicle transmissions, are equipped with knobs at their ends. Such knobs are provided as handles for operators. For fastening a knob on a control lever, the knob is provided with a receiving opening for the control lever. Because of possible tolerances during manufacturing of the control lever, there is a danger that, if the control lever rod has a smaller dimension, the knob will be loose on the rod and, as a result, a secure fixing of the knob on the control lever rod will no longer be ensured. On the other hand, if the control lever rod has a larger dimension, there is a risk that it will be unable to be slid into the receiving opening of the knob.

It is therefore an object of the present invention to develop a knob which ensures a secure and durable fixing of the knob on the control lever despite possible tolerances, particularly with respect to dimensions of the control lever.

This object is achieved by means of the claimed invention.

Because the receiving device for the control lever at least partially has a lining of a flexible material, the inside diameter of the receiving device is reduced. When the knob or the handle piece is fitted onto the control lever, this flexible material is displaced and used as a radial contact surface for the control lever rod. Also, in the case of tolerance deviations with respect to the dimensions of the control lever rod, a secure fixing of the knob on the control lever is thereby ensured.

Additional advantageous further embodiments and further developments of the knob can also be obtained.

The basic body of the knob has a shaft part and a head part which are surrounded by an enveloping body. Openings are provided in the surface area of the shaft, which openings are penetrated by sections of the enveloping body. The elastically constructed enveloping body improves the haptics of the knob. Simultaneously, the sections of the enveloping body engaging in the openings of the shaft present a lining for the receiving device which ensures a firm fit of the knob on the control lever.

The openings extend in the axial direction as well as in the circumferential direction of the shaft part so as to provide a secure and durable fixing of the knob on the control lever.

The openings provided in the shaft part are constructed as window-type recesses, so that, in an advantageous manner, the sections of the enveloping body penetrating the recesses form ribs which are used as contact surfaces or as a lining for the control lever section situated in the receiving device. While the basic body consists of a hard plastic material, the enveloping body is constructed of an elastic thermoplastic material or of another soft material, such as polyurethane.

For axially fastening the knob on the control lever, a detent device is provided in the head part of the basic body. The detent device has several snap hooks which interact with a recess made in the control lever. The snap hooks are provided on the outside with ribs for stiffening purposes.

Exterior ribs are molded on so as to extend from the shaft part to the head part of the basic body in order to provide better anchoring of the enveloping body on the basic body.

The section of the control lever fitted into the receiving device of the knob is flattened on both sides, and the interior contour of the receiving device of the knob is adapted to the contour of this control lever section. As a result, the knob is fastened on the control lever in a twist-proof manner. In this case, the flattened sides of the control lever are used as contact surfaces for the ribs shaped out of the enveloping body.

The basic body is fitted onto a control lever device, which is a replica of the control lever, and is enclosed by a mold in order to produce the knob. For applying the enveloping body, this mold is filled with an elastic thermoplastic synthetic material, for example by injection molding for applying the enveloping body. As an alternative, the enveloping body is foamed out with a polyurethane foam, the ribs for the radial fixing of the knob on the control lever being produced simultaneously. After hardening, the knob can be pulled off the control lever device and, optionally after its finishing, can be fixed on the actual control lever.

In addition, a label carrier is provided on the face of the knob. Furthermore, laterally on the head of the knob, two moldings are fastened to the basic body. For a further visual upgrading of the knob, the latter is covered with leather.

An embodiment of the invention is illustrated in the drawings and will be explained in detail in the following.

### BRIEF DESCRIPTION OF THE DRAWINGS

FIG. 1 is a perspective view of a basic body of a knob;

FIG. 2 is a lateral view of the basic body of the knob;

FIG. 3 is a sectional view of a completed knob along the line III-III in FIG. 2;

FIG. 4 is a view of an enveloping body of the knob;

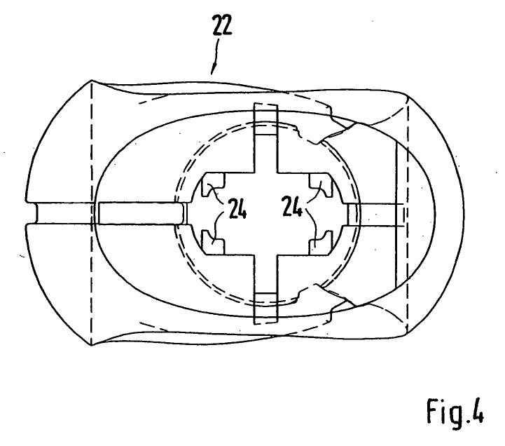

FIG. 5 is a first partial view of a control lever; and

FIG. 6 is a second partial view of the control lever.

### DETAILED DESCRIPTION OF THE INVENTION

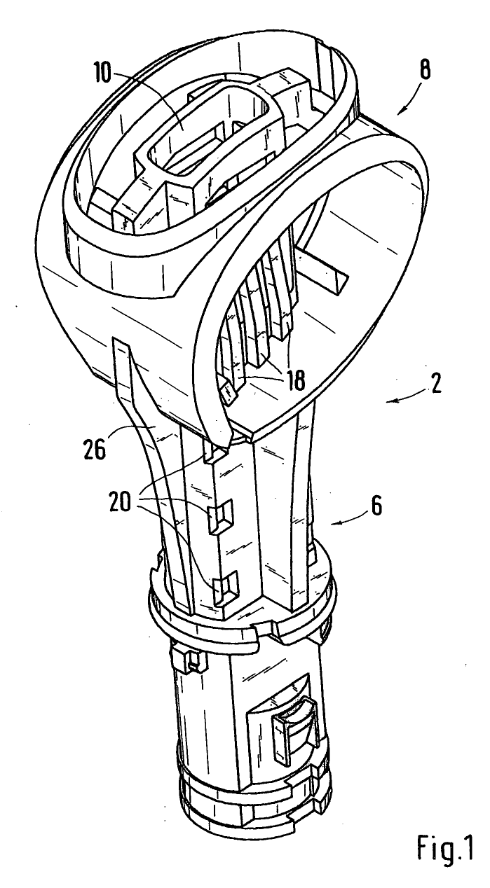

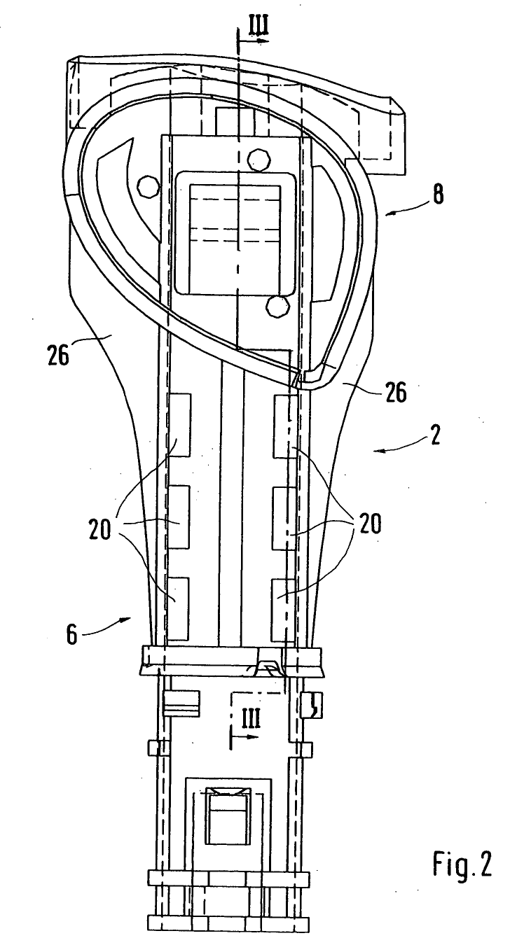

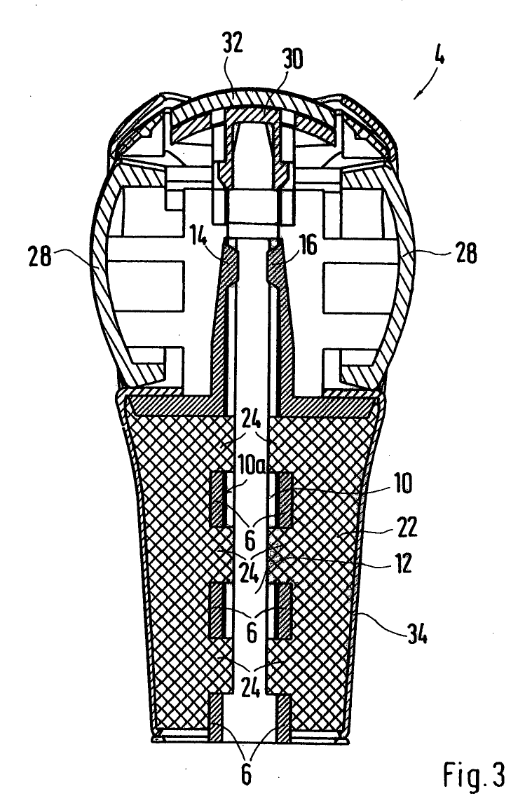

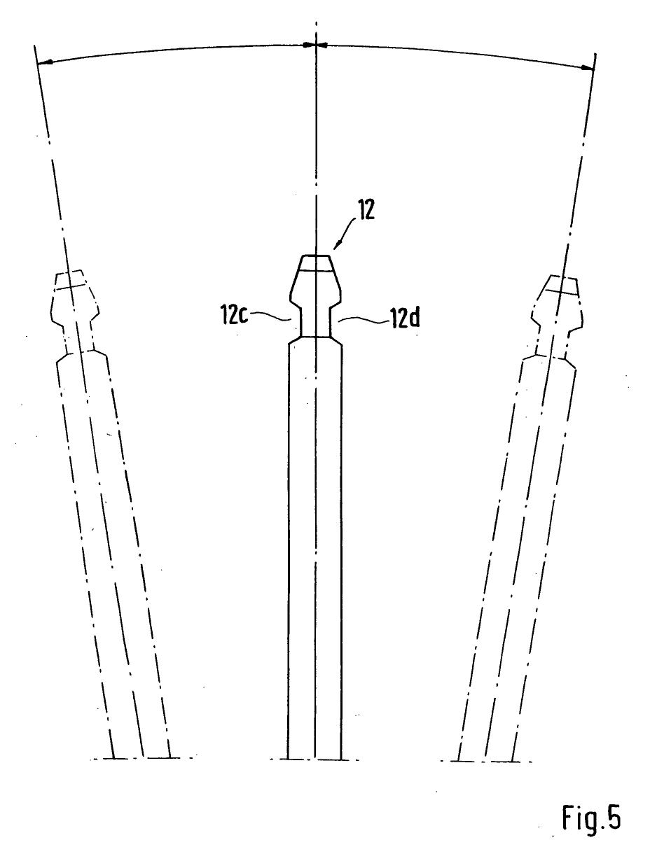

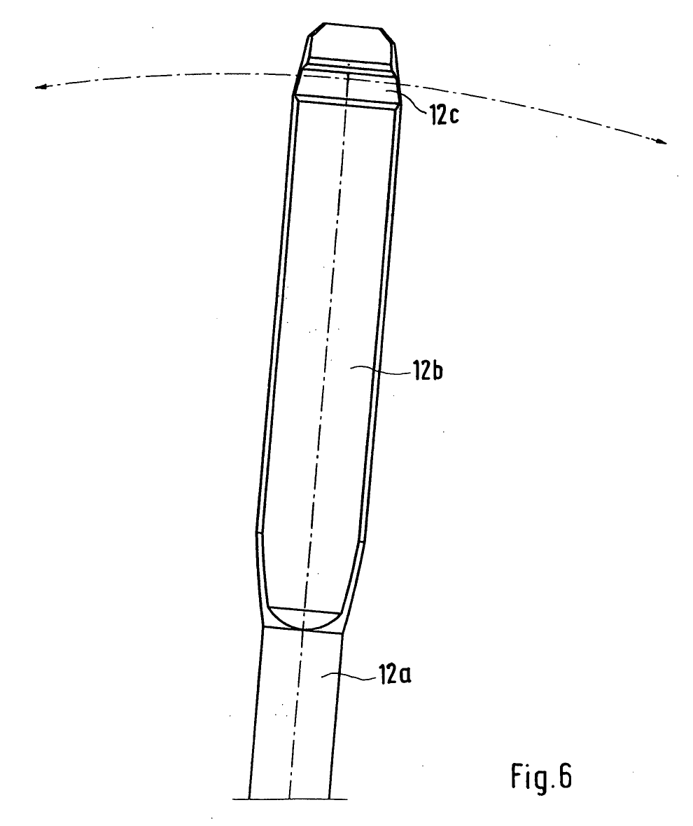

FIGS. 1 and 2 illustrate a basic body 2, which consists of a hard plastic material, of a knob 4 shown as a longitudinal sectional view in FIG. 3. In this case, the basic body 2 is divided into a shaft part 6 and a head part 8. A receiving device 10 for a control lever 12 is provided in the interior of the basic body 2. The control lever 12 is provided as a shifting or selecting lever for the selection of gears of a motor vehicle transmission and, for reasons of simplification, will only be called shift lever 12 in the following. The shift lever 12 has a tube-shaped section 12a leading to a shifting gate, which is not shown, while a section 12b of the shift lever 12 flattened toward both sides is fitted into the receiving device 10. In FIG. 5, the preselecting movement of the gears is illustrated by a lateral swivelling of the shift lever 12, and for engaging the gears, the shift lever 12 is moved in the direction illustrated in FIG. 6 by the dash-dotted line. As illustrated in FIG. 3, the recess 10 is provided with a larger inside diameter in the area of the flattened section 12b of the shift lever 12, so that a corresponding clearance is formed between the interior wall 10a of the recess 10 and the flattened section 12b.

For axially securing the basic body 2 or the knob 4 on the shift lever 12, two recesses 12c and 12d are provided at the upper end of the flattened section 12b. Snap hooks 14 and 16, each of which is shaped out of the head part 8, formlockingly engage in the two recesses 12c and 12d. The snap hooks 14, and 16 are equipped with reinforcing ribs 18 on their exterior sides for stiffening of the snap hooks. In this case, the head part 8 shaped out of the basic body 2 is shown as a sectional view only in the area of the snap hooks 14, 16 in FIG. 3.

On its lateral surface, the shaft part 6 of the basic body 2 has openings 20 which extend in the axial as well as in the circumferential direction and are constructed as window-type recesses and are connected with the receiving device 10 for the shift lever 12. As illustrated in FIG. 3, the openings 20 are penetrated by sections 24 of an enveloping body 22 surrounding the basic body 2. Because of the window-type recesses, these sections 24 are constructed as ribs 24. The ribs 24 are used as radial contact surfaces for the flattened section 12b of the shift rod 12, so that the knob 4 is thereby fastened in a twist-proof and play-free manner on the shift rod 12. The ribs 24 and therefore also the enveloping body 22 consist of an elastic thermoplastic synthetic material so that, despite deviations in the outer dimensions of the flattened section 12b of the shift rod 12, a secure fastening of the knob 4 on the shift lever 12 is ensured.

The basic body 2 has ribs 26 extending from the shaft part to the head part 6, 8, which ribs 26 ensure a better anchoring of the enveloping body 22 on the basic body 2.

Furthermore, the head part 8 of the basic body 2 laterally has two openings, each of which is respectively covered by one molding 28. At the upper end of the shift lever 12, a label carrier 30 is fitted on, to which, in turn, a label 32 is affixed, which indicates, for example, the shifting arrangement of the individual gears. For a visual upgrading, the enveloping body 22 is also provided with a covering 34, which, for example, is made of leather.

The knob 4 is produced as follows:

The basic body 2 is fitted onto a shift rod device and is surrounded by a mold held at a distance from the basic body 2, whose negative corresponds to the outer contour of the later enveloping body 22. For producing the enveloping body 22, the elastic thermoplastic synthetic material is then injected, or another soft material, such as polyurethane, is foamed in. After hardening of the foamed-in material, the mold is removed, and the knob 4 is completed by mounting the moldings 28, the label carrier 30, the label 32 and the covering 34. Since the ribs 24 or the enveloping body 22 as a whole are constructed of an elastic material, the foamed-out knob 4 can be withdrawn from the shift rod device without any damage.

The shift knob is naturally not limited to application to shifting of gears of a motor vehicle transmission, but can be used for control levers in general.

1-12. (canceled)

13. A knob or grip end for a control lever of a motor vehicle, comprising:
a knob body which has a receiving device for the control lever, and
a lining, made of a flexible material, by which the knob can be fastened on the control lever.

14. The knob or grip end according to claim 13, wherein the knob body has a basic body with a shaft part and a head part which are surrounded at least partially by an elastically constructed enveloping body, and wherein openings are provided in a lateral surface of the shaft part and are penetrated by sections of the enveloping body.

15. The knob or grip end according to claim 14, wherein the openings extend in axial and circumferential directions of the shaft part.

16. The knob or grip end according to claim 14, wherein the openings are constructed as window-type recesses, and wherein the sections of the enveloping body engaging in the recesses form ribs.

17. The knob or grip end according to claim 14, wherein the basic body is of a hard plastic material and the enveloping body is of an elastic thermoplastic synthetic material or polyurethane.

18. The knob or grip end according to claim 14, wherein a detent device for axially fixing the knob on the control lever is provided in the head part of the basic body.

19. The knob or grip end according to claim 18, wherein the detent device has several snap hooks which engage in recesses provided at the control lever.

20. The knob or grip end according to claim 19, wherein the snap hooks are equipped with ribs on their exterior sides for reinforcement.

21. The knob or grip end according to claim 14, wherein outer ribs extending from the shaft part to the head part of the basic body are provided for anchoring the enveloping body.

22. The knob or grip end according to claim 16, wherein the control lever is flattened on both sides in the area of the receiving device.

23. The knob or grip end according to claim 22, wherein flattened sides of the control lever form contact surfaces for the ribs.

24. The knob or grip end according to claim 14, wherein the enveloping body is produced by spraying-out or foaming-out of a mold receiving the basic body.

25. The knob or grip end according to claim 15, wherein the openings are constructed as window-type recesses, and wherein the sections of the enveloping body engaging in the recesses form ribs.

26. The knob or grip end according to claim 15, wherein the basic body is of a hard plastic material and the enveloping body is of an elastic thermoplastic synthetic material or polyurethane.

27. The knob or grip end according to claim 16, wherein the basic body is of a hard plastic material and the enveloping body is of an elastic thermoplastic synthetic material or polyurethane.

28. The knob or grip end according to claim 15, wherein a detent device for axially fixing the knob on the control lever is provided in the head part of the basic body.

29. The knob or grip end according to claim 28, wherein the detent device has several snap hooks which engage in recesses provided at the control lever.

30. The knob or grip end according to claim 29, wherein the snap hooks are equipped with ribs on their exterior sides for reinforcement.

31. The knob or grip end according to claim 15, wherein outer ribs extending from the shaft part to the head part of the basic body are provided for anchoring the enveloping body.

32. The knob or grip end according to claim 15, wherein the enveloping body is produced by spraying-out or foaming-out of a mold receiving the basic body.
